(19) United States
(12) Patent Application Publication
(10) Pub. No.: US 2025/0175237 A1
(43) Pub. Date: May 29, 2025

(54) BEAM FAILURE MONITORING AND RECOVERY IN SIDELINK

(71) Applicant: Telefonaktiebolaget LM Ericsson (publ), Stockholm (SE)

(72) Inventor: Antonino ORSINO, Kirkkonummi (FI)

(21) Appl. No.: 18/695,421

(22) PCT Filed: Sep. 26, 2022
(86) PCT No.: PCT/EP2022/076681

§ 371 Date: Mar. 26, 2024

Related U.S. Application Data
(60) Provisional application No. 63/248,650, filed on Sep. 27, 2021.

(51) Int. Cl. H04B 7/06; H04B 17/318; H04W 72/25

(52) U.S. Cl. CPC H04B 7/06964; H04B 17/328; H04W 72/25

(57) ABSTRACT

According to an aspect, there is provided a method of operating a first sidelink communication device of a communications network. The first sidelink communication device is configured to support multi-beam operations. The method includes determining information associated with a wireless connection between the first sidelink communication device and a second sidelink communication device of the communications network; detecting beam failure associated with a beam associated with the wireless connection based on the information; and performing beam failure recovery by triggering sidelink discovery of a new sidelink communication device.

### TECHNICAL FIELD

The present disclosure is related to wireless communication systems and more particularly to beam failure monitoring and recovery in sidelink.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

NR vehicle-to-everything (“V2X”) is described below. Cellular Intelligent Transport Systems (“ITS”) aims at defining a new cellular eco-system for the delivery of vehicular services and their dissemination. Such an eco-system includes both short range and long range V2X service transmissions, as depicted in FIG. 2. In particular, short range communication involves transmissions over the Device-to-Device (“D2D”) link, also defined as sidelink or PC5 interface in 3rd Generation Partnership Project (“3GPP”), towards other vehicular UEs or road side units (“RSU”). On the other hand, for long range transmission, it considers the transmission over the Uu interface between a UE and a base station, in which case packets may be disseminated to different ITS service providers, which could be road traffic authorities, road operators, automotive Original Equipment Manufacturers (OEMs), cellular operators, etc.

When it comes to the sidelink (SL) interface, the first standardization effort in 3GPP dates back to Release 12 (Rel. 12), targeting public safety use cases. Since then, a number of enhancements have been introduced with the objective to enlarge the use cases that could benefit of the D2D technology. Particularly, in Long Term Evolution (LTE) Rel-14 and Rel-15, the extensions for the D2D work consists of supporting V2X communication, including any combination of direct communication between vehicles (“V2V”), pedestrians (“V2P”) and infrastructure (“V2I”).

In RAN #80, a new Study Item named “Study on NR V2X” was approved to study the enhancement to support advanced V2X services beyond services supported in LTE Rel-15 V2X. One of the objectives for NR V2X design is to study technical solutions for quality of service (“QoS”) management of the radio interface including both Uu (i.e. network-to-vehicle UE communication) and sidelink (i.e. vehicle UE-to-vehicle UE communication) used for V2X operations.

While LTE V2X mainly aims at traffic safety services, NR V2X has a much broader scope including not only basic safety services, but also targeting non-safety applications, such as extended sensor/data sharing between vehicles, with the objective to strengthen the perception of the surrounding environment of vehicles. Hence, a new set of applications have been captured in TR 22.886 v16.2.0, such as advanced driving, vehicles platooning, cooperative maneuver between vehicles and remote driving that would require enhanced NR system and new NR sidelink framework.

In this new context, the expected requirements to meet the needed data rate, capacity, reliability, latency, communication range and speed are made more stringent. What is more, both communication interfaces, PC5 and Uu, could be used to support the advanced V2X use cases, taking into account radio conditions and the environment where the enhanced V2X (“eV2X”) scenario takes place. For example, given the variety of services that can be transmitted over the sidelink, a robust QoS framework which takes into account the different performance requirements of the different V2X services seems to be needed. Additionally, new radio protocols to handle more robust and reliable communication should be designed. All of these issues are currently under the investigation of 3GPP in NR Rel. 16.

NR sidelink flow and radio bearer configuration provision are described below. In NR, sidelink (“SL”) QoS flow model is adopted. At Non-Access Stratum (NAS) layer, UE maps one V2X packet into the corresponding SL QoS flow and then maps to a SL radio bearer at service data adaptation protocol (“SDAP”) layer.

In NR, SL radio bearer (“SLRB”) configuration, including the QoS flow to SLRB mapping, is either preconfigured or configured by the network (“NW”) when the UE is in coverage. For instance, as shown in FIG. 3, when UE wants to establish a new SL QoS flow/SLRB for a new service, it can send a request to the associated gNB. The request can include the QoS information of the service. gNB then determines appropriate SLRB configuration to support such SL QoS flow. After receiving the SLRB configuration from gNB, the UE establishes the local SLRB accordingly and prepare for data transmission over the SL. Note that to enable successful reception at the reception (“RX”) UE side, transmission (“TX”) UE might have to inform RX UE regarding necessary parameters, e.g. sequence number space for Packet Data Convergence Protocol (PDCP)/Radio Link Control (RLC), before the data transmission starts.

A Beam Failure Detection and Recovery procedure is described below. This description is based on section 3GPP TS 38.321 v17.1.0 section 5.17. The medium access control (“MAC”) entity may be configured by radio resource control (“RRC”) per Serving Cell with a beam failure recovery procedure which is used for indicating to the serving gNB of a new synchronization signal block (“SSB”) or channel state information (CSI) reference signal (RS) (“CSI-RS”) when beam failure is detected on the serving SSB(s)/CSI-RS(s). Beam failure is detected by counting beam failure instance indication from the lower layers to the MAC entity. If beamFailureRecoveryConfig is reconfigured by upper layers during an ongoing Random Access (RA) procedure for beam failure recovery for Special Cell (SpCell), the MAC entity shall stop the ongoing Random Access procedure and initiate a Random Access procedure using the new configuration.

RRC configures the following parameters in the BeamFailureRecoveryConfig, BeamFailureRecoverySCellConfig, and the RadioLinkMonitoringConfig for the Beam Failure Detection and Recovery procedure: beamFailureInstanceMaxCount for the beam failure detection; beamFailureDetectionTimer for the beam failure detection; beamFailureRecoveryTimer for the beam failure recovery procedure; rsrp-ThresholdSSB: an RSRP threshold for the SpCell beam failure recovery; rsrp-ThresholdBFR: an RSRP threshold for the SCell beam failure recovery; powerRampingStep: powerRampingStep for the SpCell beam failure recovery; powerRampingStepHighPriority: powerRampingStepHighPriority for the SpCell beam failure recovery; preambleReceivedTargetPower: preambleReceivedTargetPower for the SpCell beam failure recovery; preambleTransMax: preambleTransMax for the SpCell beam failure recovery; scalingFactorBI: scalingFactorBI for the SpCell beam failure recovery; ssb-perRACH-Occasion: ssb-perRACH-Occasion for the SpCell beam failure recovery using contention-free Random Access Resources; ra-ResponseWindow: the time window to monitor response(s) for the SpCell beam failure recovery using contention-free Random Access Resources; prach-ConfigurationIndex: prach-ConfigurationIndex for the SpCell beam failure recovery using contention-free Random Access Resources; ra-ssb-OccasionMaskIndex: ra-ssb-OccasionMaskIndex for the SpCell beam failure recovery using contention-free Random Access Resources; ra-OccasionList: ra-OccasionList for the SpCell beam failure recovery using contention-free Random Access Resources; candidateBeamRSList: list of candidate beams for SpCell beam failure recovery; and candidateBeamRSSCellList: list of candidate beams for SCell beam failure recovery.

The following UE variables are used for the beam failure detection procedure:
BFI_COUNTER (per Serving Cell): counter for beam failure instance indication which is initially set to 0.

The MAC entity shall for each Serving Cell configured for beam failure detection:
1> if beam failure instance indication has been received from lower layers:
   2> start or restart the beamFailureDetection Timer,
   2> increment BFI_COUNTER by 1;
   2> if BFI_COUNTER>=beamFailureInstanceMaxCount:
      3> if the Serving Cell is SCell:
         4> trigger a BFR for this Serving Cell;
      3> else:
         4> initiate a Random Access procedure (see clause 5.1) on the SpCell.
1> if the beamFailureDetection Timer expires; or
1> if beamFailureDetection Timer, beamFailureInstanceMaxCount, or any of the reference signals used for beam failure detection is reconfigured by upper layers associated with this Serving Cell:
   2> set BFI_COUNTER to 0.
1> if the Serving Cell is SpCell and the Random Access procedure initiated for SpCell beam failure recovery is successfully completed (see clause 5.1):
   2> set BFI_COUNTER to 0;
   2> stop the beamFailureRecoveryTimer, if configured;
   2> consider the Beam Failure Recovery procedure successfully completed.
1> else if the Serving Cell is SCell, and a PDCCH addressed to C-RNTI [Cell-Radio Network Temporary Identifier] indicating uplink grant for a new transmission is received for the HARQ [Hybrid Automatic Repeat Request] process used for the transmission of the BFR MAC CE or Truncated BFR MAC CE which contains beam failure recovery information of this Serving Cell; or
1> if the SCell is deactivated as specified in clause 5.9:
   2> set BFI_COUNTER to 0;
   2> consider the Beam Failure Recovery procedure successfully completed and cancel all the triggered BFRs for this Serving Cell.

The MAC entity shall:
1> if the Beam Failure Recovery procedure determines that at least one BFR has been triggered and not cancelled for an SCell for which evaluation of the candidate beams according to the requirements as specified in TS 38.133 has been completed:
   2> if UL-SCH [Synchronization Channel] resources are available for a new transmission and if the UL-SCH resources can accommodate the BFR MAC CE plus its subheader as a result of LCP:
      3> instruct the Multiplexing and Assembly procedure to generate the BFR MAC CE.
   2> else if UL-SCH resources are available for a new transmission and if the UL-SCH resources can accommodate the Truncated BFR MAC CE plus its subheader as a result of LCP:
      3> instruct the Multiplexing and Assembly procedure to generate the Truncated BFR MAC CE.
   2> else:
      3> trigger the SR for SCell beam failure recovery for each SCell for which BFR has been triggered, not cancelled, and for which evaluation of the candidate beams according to the requirements as specified in TS 38.133 has been completed.

All Beam Failure Recoveries (BFRs) triggered for a Secondary Cell (SCell) shall be cancelled when a MAC Protocol Data Unit (PDU) is transmitted and this PDU includes a BFR MAC Control Element (CE) or Truncated BFR MAC CE which contains beam failure information of that SCell.

Machine learning can be used to find a predictive function for a given dataset; the dataset is typically a mapping between a given input to an output. The predictive function (or mapping function) is generated in a training phase, where the training phase assumes knowledge of both the input and output. The test phase comprises predicting the output for a given input. Applications of machine learning are for example curve fitting, facial recognition and spam filter. FIGS. 4A-B illustrate examples of one type of machine learning, namely classification, where the task is to train a predictive function that separates the two classes (circle and cross class). In FIG. 4A, features 1 and 2 provide low separation of the output class, hence leading to a worse prediction performance in comparison with the FIG. 4B in which using features 3 and 4 enable a better separation and classifying performance. In general, the performance of the machine learner is proportional to the correlation between the input and the output, one key problem in machine learning is to find/create good features, another problem is to collect enough data samples.

An example of classification in a radio context is the prediction of coverage on a frequency different from the serving frequency (here called secondary frequency) based on measurements on a serving frequency. In such an example, one could predict the reference signal receive power (“RSRP”) of a secondary frequency based on the RSRP, TA and precoder index of cells on a serving frequency (including neighbor cells). The data could be collected through measurement reports or through specific combinations of events such as A2 or A5 and inter-frequency measurement reports. Once trained, the ML model will be able to output an estimate of coverage for different frequencies, for new input data, which can be utilized in different ways such as in mobility to filter out relevant frequency candidates.

One such example is shown in FIG. 5, where a network has trained a decision tree for predicting the coverage probability on another carrier given 5 different measurements on the source carrier. The measurement could represent an RSRP or Reference Signal Received Quality (RSRQ) measurement of the serving or neighboring cell in LTE context, or a RSRP/RSRQ beam measurement in NR context. The coverage probability is denoted by p, and no coverage (also known as out of coverage—OoC) is naturally defined as (1-p), Note that each leaf node will provide a different coverage probability p (p1-p8).

### SUMMARY

There currently exist certain challenges. It is undecided whether to support sidelink communication in an unlicensed band for frequency range 1 (“FR1”) (e.g., frequencies ranging from 450 MHz to 6 GHz) and/or to enhance sidelink communication in a licensed band for frequency range 2 (“FR2”) (e.g., frequencies ranging from 24.25 GHz to 52.6 GHz). However, it is clear that the support of FR2 for sidelink is one of the probable topics that will be addressed in the next Rel-18 and, together with it, also the beam management feature (for both monitoring and recovery). So far, there is no support of FR2 in sidelink either in LTE or in NR and thus new methods and solutions would need to be standardized in order to handle the beam management. One fundamental difference with Uu NR is that in sidelink there is no Random Access Channel (RACH) and thus the beam failure monitoring and recovery has to be different.

Certain aspects of the disclosure and their embodiments may provide solutions to these or other challenges.

According to a first aspect, there is provided a method of operating a first network entity sidelink communication device of a communications network. The first network entity sidelink communication device is configured to support multi-beam operations, and the method comprises: determining information associated with a wireless connection between the first network entity sidelink communication device and a second network entity sidelink communication device of the communications network; detecting beam failure associated with a beam associated with the wireless connection based on the information; and performing beam failure recovery by triggering sidelink discovery of a new sidelink communication device.

According to a second aspect, there is provided a first sidelink communication device configured to operate in a communications network. The first sidelink communication device is configured to support multi-beam operations, and is configured to: determine information associated with a wireless connection between the first sidelink communication device and a second sidelink communication device of the communications network; detect beam failure associated with a beam associated with the wireless connection based on the information; and perform beam failure recovery by triggering sidelink discovery of a new sidelink communication device.

According to a third aspect, there is provided a first sidelink communication device for operations in a communications network. The first sidelink communication device is operative to support multi-beam operations and the first sidelink communication device comprises processing circuitry and memory coupled to the processing circuitry. The memory has instructions stored therein that are executable by the processing circuitry to cause the first sidelink communication device to be operative to: determine information associated with a wireless connection between the first sidelink communication device and a second sidelink communication device of the communications network; detect beam failure associated with a beam associated with the wireless connection based on the information; and perform beam failure recovery by triggering sidelink discovery of a new sidelink communication device.

According to a fourth aspect, there is provided a computer program product comprising a non-transitory storage medium including program code to be executed by processing circuitry of a first sidelink communication device operating in a communications network, whereby execution of the program code causes the first sidelink communication device to perform operations comprising any operations of the first aspect or any embodiment thereof.

Various embodiments herein enable a sidelink UE to perform beam failure monitoring and recovery when sidelink is deployed in FR2 or any other frequency that supports multi-beam operations. In some embodiments, a sidelink UE is configured to operate on a sidelink frequency that supports multi-beam operations, and when performing beam monitoring on a single beam it takes into account at least one (or a combination) of the following criteria: The SL RSRP, RSRQ, Signal to interference plus noise ratio (SINR), Received Signal Strength Indicator (RSSI) over PC5; Distance between two sidelink UEs; Mobility of the two sidelink UEs; Indication received by the peer UE that the channel quality on a given beam is going to decrease/deteriorate; and Traffic inactivity (i.e., no sidelink transmissions for a given timer period). In additional or alternative embodiments, a UE when performing beam monitoring may track the criteria mentioned over a period of time and may compare them with a threshold. In additional or alternative embodiments, the evaluation of the mentioned criteria can be a one-shot evaluation that may then be compared with a threshold.

In additional or alternative embodiments, a sidelink UE configured to operate on a sidelink frequency that supports multi-beam operations detects beam failure when at least one (or a combination) of the following events happen: 1) The channel quality over the serving beams goes above/below a threshold or is above a first threshold and below a second threshold; 2) The channel quality over “N” beam goes above/below a threshold or is above a first threshold and below a second threshold; 3) The channel quality over the serving beams goes above/below a threshold or is above a first threshold and below a second threshold for a certain period of time (i.e., a timer is started); 4) The channel quality over “N” beam goes above/below a threshold or is above a first threshold and below a second threshold for a certain period of time (i.e., a timer is started); 5) The distance between the two sidelink UEs goes below a threshold; 6) The sidelink UE receive an indication by its peer UE that the serving beam is going to fail soon; 7) When the sidelink UE sends traffic for “M” attempts over the serving beam but does not receive a reply from the peer UE; or 8) When the sidelink UE sends traffic over the serving beam but does not receive a reply from the peer UE after a certain period of time (i.e., a timer may be used).

In additional or alternative embodiments, a sidelink UE configured to operate on a sidelink frequency that supports multi-beam operations when performing beam failure recovery, pursues or performs at least one (or a combination) of the following actions: 1) The sidelink UE triggers sidelink discovery in order to discover a new peer UE; 2) The sidelink UE tries to send a new signalling to the peer UE (over one of the non-failed beams or via broadcast) in order to restore the sidelink connection e.g., by switching from a multi-beam to a single beam operation or by switching from a frequency supporting multi beam operation to a frequency supporting only single beam operations; 3) The sidelink UE sends an indication to the network to inform the network that beam failure has been detected and, eventually, request a new configuration; 4) The sidelink UE switches from a sidelink communication to a

Uu communication (in such a case the sidelink UE may need to perform RACH if in RRC_IDLE or RRC_INACTIVE); and 5) The sidelink UE releases the current sidelink connection with its peer UE.

Certain embodiments may provide one or more of the following technical advantages. In some embodiments, a sidelink UE that is configured to operate on a sidelink frequency that supports multi-beam operations is able to perform beam failure detection and recovery. This can prevent the sidelink UE from releasing the sidelink connection every time that a failure is experienced on the serving beam. The benefits of this are a short connection interruption and a prolonged service continuity and connection reliability.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a schematic diagram illustrating an example of a C-ITS environment;

FIG. 3 is a schematic diagram illustrating an example of a NR SL radio bearer configuration provided from a network;

FIGS. 4A-B are graphs illustrating examples of classification with machine learning;

FIG. 5 is a block diagram illustrating an example of a decision tree for predicting the coverage probability on another carrier given a set of measurements on a primary carrier;

FIG. 6 is a block diagram illustrating a communication device according to some embodiments;

FIG. 7 is a block diagram illustrating a radio access network (RAN) node (e.g., a base station eNB/gNB) according to some embodiments;

FIG. 8 is a block diagram illustrating a core network CN node (e.g., an AMF node, an SMF node, etc.) according to some embodiments;

FIG. 9 is a flow chart illustrating an example of operations of a network entity according to some embodiments;

FIG. 10 is a block diagram of a communication system in accordance with some embodiments;

FIG. 11 is a block diagram of a user equipment in accordance with some embodiments

FIG. 12 is a block diagram of a network node in accordance with some embodiments;

FIG. 13 is a block diagram of a host computer communicating with a user equipment in accordance with some embodiments;

FIG. 14 is a block diagram of a virtualization environment in accordance with some embodiments; and

FIG. 15 is a block diagram of a host computer communicating via a base station with a user equipment over a partially wireless connection in accordance with some embodiments in accordance with some embodiments.

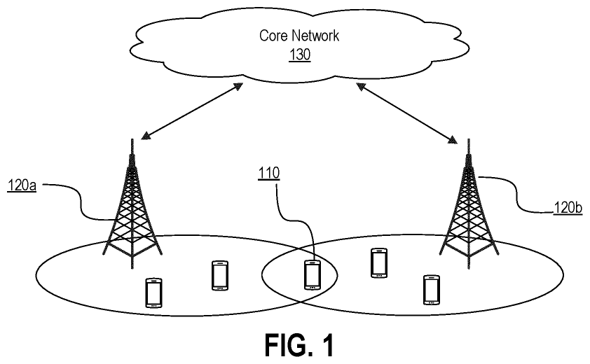

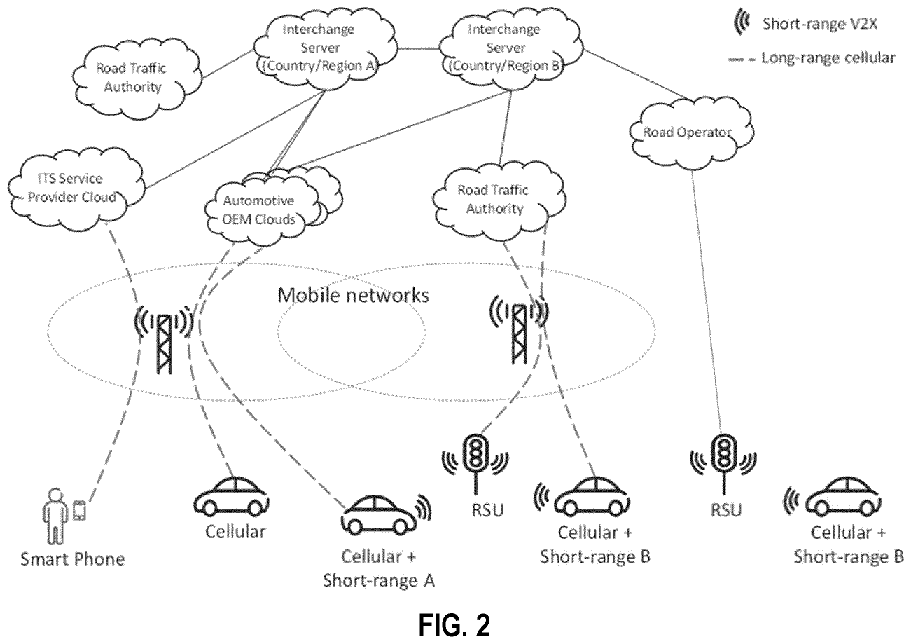

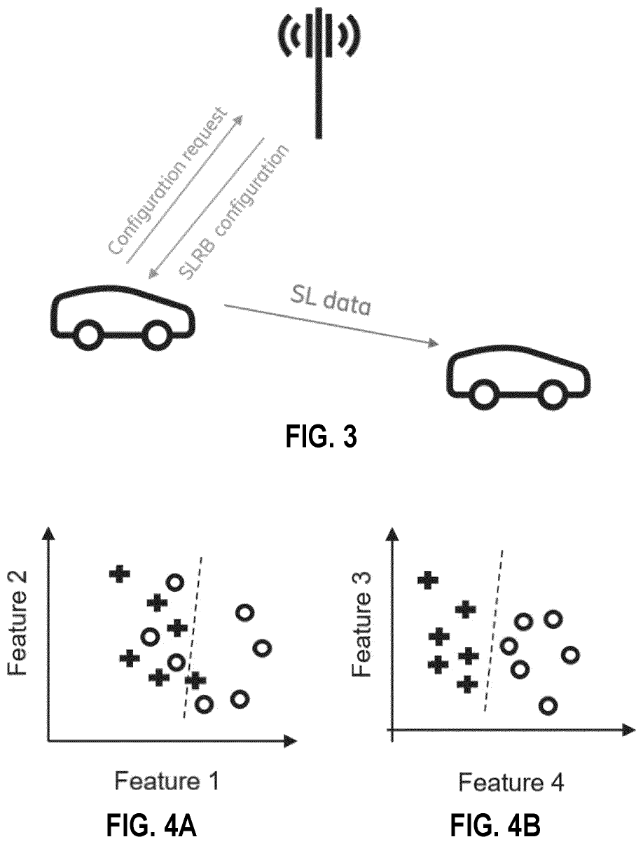

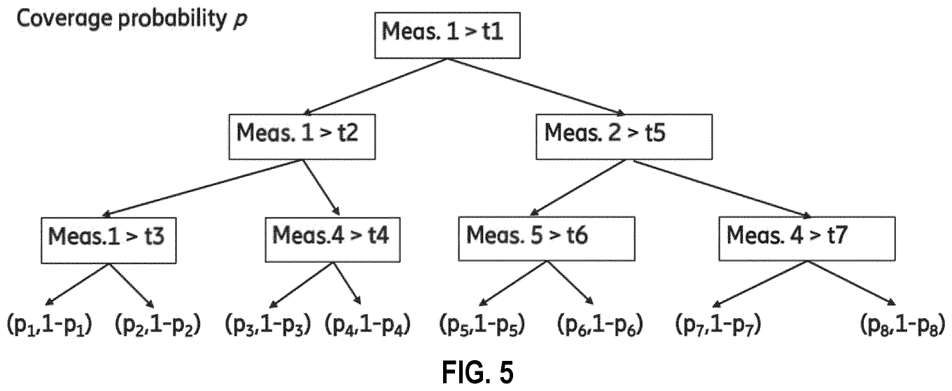

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Some embodiments herein refer to the NR radio access technology (RAT) but can be applied also to LTE RAT and any other RAT enabling the direct transmission between two (or more) nearby devices without any loss of meaning.

Further, what it described in the following applies without any loss of meaning to “sidelink standalone” that is defined as the direct transmission between two nearby devices and to “sidelink relay” that is referred to a communication that is generated by a remote UE and is terminated at a gNB (or another destination remote UE) via the use of an intermediate node called relay UE.

In the following, the term “sidelink UE” and “peer UE” are used, but these can be exchanged without any loss of meaning with “remote UE” and/or “relay UE” in case sidelink relay is considered.

Please note that the following embodiments are written in regards to sidelink, but all the embodiments can be applied without any loss of meaning also to those technologies (or RAT) where multi beam operations are used by one node (e.g., in NR Uu, or LTE Uu).

Metrics to consider for performing beam monitoring are described below.

In some embodiments, a sidelink UE is configured to operate on a sidelink frequency that supports multi-beam operations when performing beam monitoring over sidelink on a single beam it takes into account at least (or a combination) of the following criteria: The SL RSRP, RSRQ, SINR, RSSI over PC5; Distance between two sidelink UEs; Mobility of the two sidelink UEs; Indication received by the peer UE that the channel quality on a given beam is going to decrease/deteriorate; and Traffic inactivity (i.e., no sidelink transmissions for a given timer period). The mobility of two sidelink UEs can be described in terms of speed, position relative to a certain time, or a combination of them. For this latter case, the mobility can be a list of waypoints where each waypoint has entries for, e.g., speed, position, time stamp, acceleration, angle of direction, etc.

In additional or alternative embodiments, the sidelink UE when performing beam monitoring over sidelink may track the criteria mentioned over a period of time and may compare them with a threshold. In additional or alternative embodiments, the evaluation of the mentioned criteria can be a one-shot evaluation that may then be compared with a threshold.

In additional or alternative embodiments, the beam monitoring over sidelink is performed by the peer UE, and when a failure event is triggered, based on the criteria mentioned above, the peer UE simply informs the sidelink UE that a failure has happened on that given beam.

Beam failure detection over sidelink is described below.

In some embodiments, a sidelink UE configured to operate on a sidelink frequency that supports multi-beam operations detects beam failure over sidelink when at least (or a combination) of the following events happen: 1) The channel quality over the serving beam goes above/below a threshold or is above a first threshold and below a second threshold; 2) The channel quality over “N” beams go above/below a threshold or is above a first threshold and below a second threshold; 3) The channel quality over the serving beam goes above/below a threshold or is above a first threshold and below a second threshold for a certain period of time (i.e., a timer is started/used); 4) The channel quality over “N” beams goes above/below a threshold or is above a first threshold and below a second threshold for a certain period of time (i.e., a timer is started/used); 5) The distance between the two sidelink UEs goes below a threshold; 6) Positioning information (e.g., Angle of arrival and/or angle or departure indicate that a certain beam may not be valid any more); 7) When the sidelink UE sends traffic for “M” attempts over the serving beam but does not receive a reply from the peer UE; 8) When the sidelink UE sends traffic for “M” attempts over “N” beams but does not receive a reply from the peer UE; 9) When the sidelink UE sends traffic over the serving beam but does not receive a reply from the peer UE after a certain period of time (i.e., a timer may be used); and 10) When the sidelink UE sends traffic over “N” beams but does not receive a reply from the peer UE after a certain period of time (i.e., a timer may be used).

In additional or alternative embodiments, the beam failure monitoring over sidelink and detection may be performed by both the sidelink UE and its peer UE at the same time. In such a case, the peer UE/sidelink UE when detecting beam failure, sends a signal to the other one of the sidelink UE/peer UE in order to inform the other UE that a beam or “N” beams have failed or are not good enough for transmitting/receiving.

In additional or alternative embodiments, the beam failure monitoring over sidelink may be done by the sidelink UE or its peer UE via a beam failure prediction. This basically means that when the sidelink UE or its peer UE “predict” that a beam failure over one of multiple beams is likely to happen, they may inform the companion UE about this. Alternatively, in another embodiment the beam failure monitoring over sidelink may be done by the sidelink UE or its peer UE via an early beam failure detection. This means that criteria used for beam monitoring are compared with a more stringent threshold so that when the beam failure is detected, the beam has not yet failed but it is going to fail soon.

In additional or alternative embodiments, if the triggering for the beam failure detection over sidelink is done based on a prediction by the sidelink/peer UE, the beam failure prediction over sidelink can be based on a machine learning model in the sidelink/peer UE or any other mathematical model that can be used for predicting a certain event or behavior. The model can be sent from the network to the sidelink/peer UE and can be trained either by the network or the sidelink/peer UE. Alternatively, the model can be sent by a sidelink UE to its peer UE (or vice versa) and can be trained by either the sidelink UE or the peer UE. Yet, in another embodiment the model can be decided by the sidelink/peer UE itself (meaning that is the UE who decide which model to use for the prediction). The input to the model can be one of the criteria described in the Example Embodiments below.

In additional or alternative embodiments, if a machine learning model is used for the beam failure detection prediction over sidelink, the UE could be configured (by the network, by a peer UE, or by its pre-configured internal model) with a time window parameter that indicates how much time in advance the UE should trigger the beam failure recovery action based on the beam failure prediction e.g. if timer window is 10 seconds, the sidelink/peer UE reports a predicted beam failure detection or trigger beam failure recovery when it is about to happen within 10 seconds (for that the sidelink/peer UE can maintain its own machine learning models for beam failure detection prediction over time depending on its conditions such as configurations and its own traffic). In another example, the sidelink/peer UE reports the predicted beam failure detection and indicates to the companion UE within how much time the radio link failure (RLF) is going to happen after the time the sidelink/peer UE has triggered the report the companion UE receives. Alternatively, the sidelink/peer UE reports the predicted beam failure detection and indicates to the network within how much time the RLF is going to happen after the time the sidelink/peer UE has triggered the report the network receives.

In additional or alternative embodiments, if the sidelink/peer UE has its own machine learning model and it receives also one from the network or a companion UE, the sidelink/peer UE chooses to use one or the other according to an explicit indication received by the network or the companion UE. Yet, in another embodiment, if the sidelink/peer UE has its own machine learning model and it also receives one from the network or companion UE, the reception of a model from the network is an implicit indication that the UE shall use by default the one received by the network. Alternatively, the UE chooses to use one or the other according to its own implementation or pre-configuration stated in the specification.

In additional or alternative embodiments, the network or a UE sends to the sidelink/peer UE a machine learning model that the sidelink/peer UE should use in order to predict a beam failure. When sending this machine learning model, the network or the UE may include at least one (or a combination) of the following: 1) The level of accuracy the prediction should have; 2) For how long the model should be used/trained by the sidelink/peer UE to predict a possible beam failure; 3) Whether the sidelink/peer UE should report the accuracy of the prediction (if this accuracy is not configured by the network, another UE, or the model itself); 4) How early the sidelink/peer UE should report the predicted beam failure. E.g., if the sidelink/peer UE predicts that a beam failure is going to happen in 10 seconds, the network or the UE can configure the sidelink/peer UE to report the predicted beam failure within 5 seconds before the beam failure is going to happen; and 5) Whether the sidelink/peer UE should report the expected duration of the beam failure.

In additional or alternative embodiments, the network or another UE may send an explicit indication to the sidelink/peer UE just to tell the sidelink/peer UE that the model sent by the network or another UE should be used. Alternatively, the network or another UE may send an explicit indication to the sidelink/peer UE to tell the sidelink/peer UE that it can use its internal machine learning model (if it has any) for the prediction of the beam failure detection.

Beam failure recovery procedures over sidelink are described below.

In some embodiments, a sidelink UE that is configured to operate on a sidelink frequency that supports multi-beam operations performs beam failure recovery over sidelink (i.e., after detecting beam failure over sidelink) by triggering sidelink discovery. In one embodiment, when the sidelink discovery is triggered the sidelink UE tries to discover a new peer UE with which to establish a new sidelink connection. Alternatively, the sidelink UE may send the discovery messages over the remaining non-failed beams and if it receives a reply (on one or multiple beams) from the peer UE, it selects one of the beams from which the reply was received as the serving beam.

In additional or alternative embodiments, a sidelink UE configured to operate on a sidelink frequency that supports multi-beam operations when performing beam failure recovery over sidelink (i.e., after detecting beam failure over sidelink) tries to send signaling over one of the non-failed beams (e.g., an RRC reconfiguration message) to the peer UE in order to restore the sidelink connection e.g., by switching from multi-beam to single beam operation or by switching from a frequency supporting multi beam operation to a frequency supporting only single beam operations. Alternatively, if all the beams have failed, the sidelink UE may send the sidelink RRC reconfiguration over sidelink groupcast or broadcast by including the identity (ID) of the peer UE (so the peer UE knows that this message is intended for it).

In additional or alternative embodiments, a sidelink UE that is configured to operate on a sidelink frequency that supports multi-beam operations performs beam failure recovery over sidelink (i.e., after detecting beam failure over sidelink) by sending an indication to the network to inform the network that beam failure has been detected and, eventually, request a new configuration. In such a case, the network may send a new configuration to the sidelink UE in order to restore the sidelink connection with the peer UE or, alternatively, the network may send a configuration to the sidelink UE in order to switch its connection from sidelink to normal Uu. Yet, in another alternative, the network may simply release the sidelink UE, the peer UE, and release its sidelink connection.

In additional or alternative embodiments, a sidelink UE that is configured to operate on a sidelink frequency that supports multi-beam operations performs beam failure recovery over sidelink (i.e., after detecting beam failure over sidelink) by switching autonomously from a sidelink communication to a Uu communication. In such a case the sidelink UE may need to perform RACH towards the network if in RRC_IDLE or RRC_INACTIVE. Further, after the sidelink UE has successfully performed the RACH to the network, it also informs the peer UE that the sidelink connection needs to be released.

In additional or alternative embodiments, a sidelink UE that is configured to operate on a sidelink frequency that supports multi-beam operations performs beam failure recovery over sidelink (i.e., after detecting beam failure over sidelink) by releasing the current sidelink connection with its peer UE.

In some embodiments, which option described in the previous embodiments the UE should use is decided by the network and communicated to the UE via dedicated RRC signaling, or via system information (SI). As an alternative, which option the UE should use is configured by a peer UE, or is pre-configured (hard-coded in the spec).

In additional or alternative embodiments, for any of the above embodiments, the signaling alternatives described will include at least one of the below.

For signaling between UE and the network: RRC signaling; MAC CE; Control PDU of a protocol layer (e.g., SDAP, PDCP, RLC or an adaptation layer in case of SL relay); or L1 signaling on channels such as Physical Random Access Channel (PRACH), Physical Uplink Control Channel (PUCCH), Physical Downlink Control Channel (PDCCH), Common Control Channel (CCCH).

For signaling between UEs: RRC signaling (e.g., PC5-RRC); PC5-S signaling; Discovery signaling; MAC CE; Control PDU of a protocol layer (e.g., SDAP, PDCP, RLC or an adaptation layer in case of SL relay); or L1 signaling on channels such as Physical Sidelink Shared Channel (PSSCH), Physical Sidelink Control Channel (PSCCH), or PSFCH.

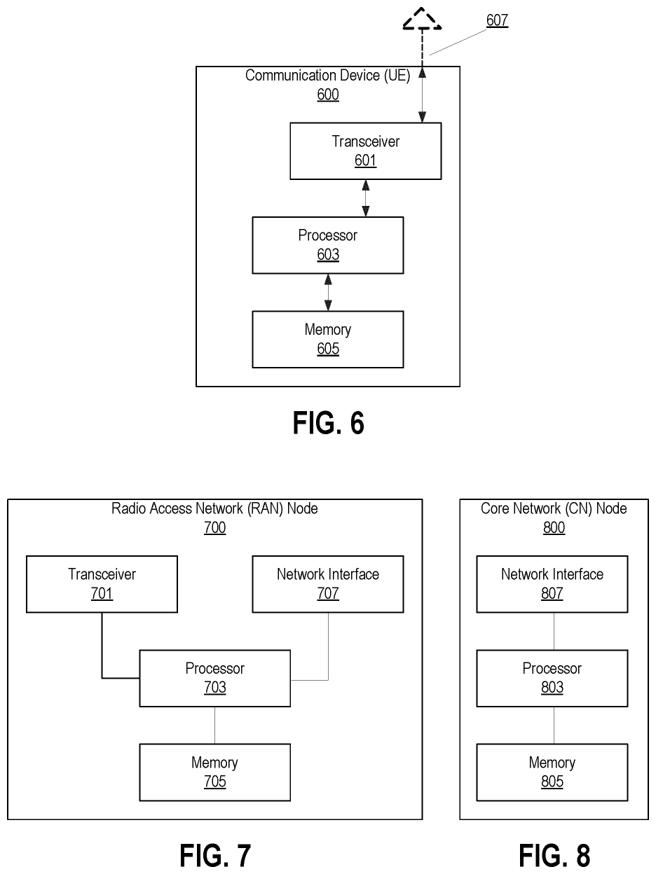

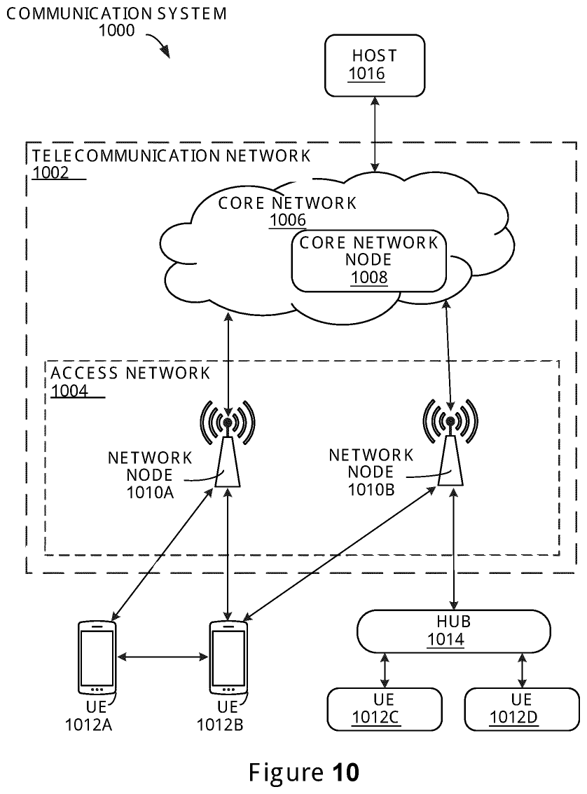

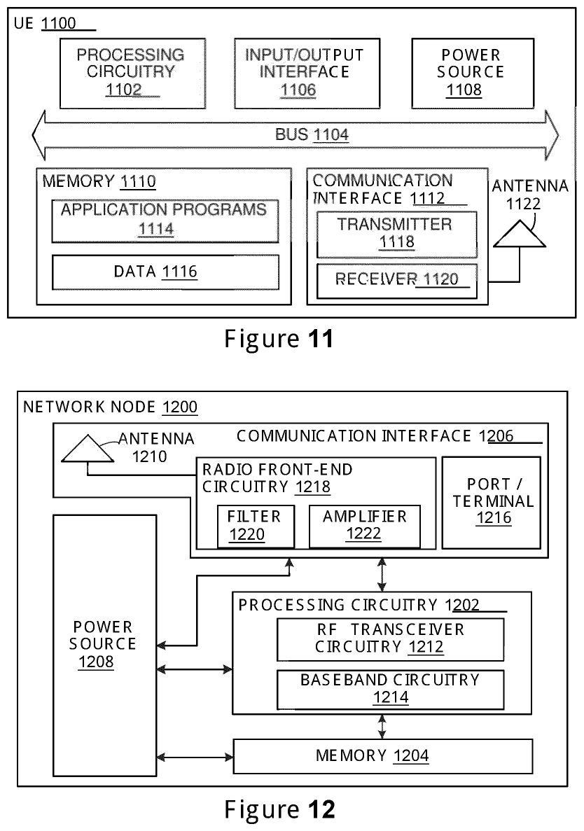

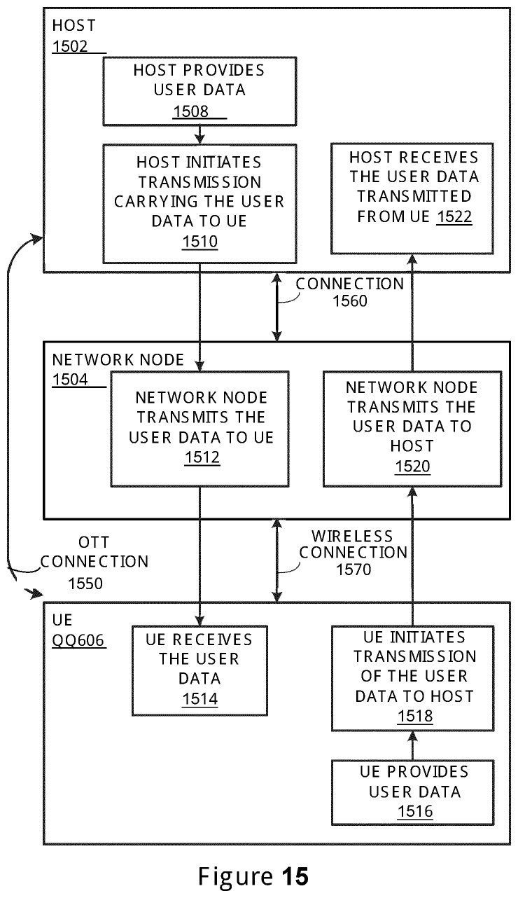

FIG. 6 is a block diagram illustrating elements of a communication device 600 (also referred to as a mobile terminal, a mobile communication terminal, a wireless device, a wireless communication device, a wireless terminal, mobile device, a wireless communication terminal, user equipment (“UE”) a user equipment node/terminal/device, etc.) configured to provide wireless communication according to embodiments of inventive concepts. (Communication device 600 may be provided, for example, as discussed below with respect to wireless devices UE 1012A, UE 1012B, and wired or wireless devices UE 1012C, UE 1012D of FIG. 10, UE 1100 of FIG. 11, virtualization hardware 1404 and virtual machines 1408A, 1408B of FIG. 14, and UE 1506 of FIG. 15, all of which should be considered interchangeable in the examples and embodiments described herein and be within the intended scope of this disclosure, unless otherwise noted.) As shown, communication device 600 may include an antenna 607 (e.g., corresponding to antenna 1122 of FIG. 11), and transceiver circuitry 601 (also referred to as a transceiver, e.g., corresponding to interface 1112 of FIG. 11 having transmitter 1118 and receiver 1120) including a transmitter and a receiver configured to provide uplink (UL) and downlink (DL) radio communications with a base station(s) (e.g., corresponding to network node 1010A, 1010B of FIG. 10, network node 1200 of FIG. 12, and network node 1504 of FIG. 15 also referred to as a RAN node) of a radio access network. Communication device 600 may also include processing circuitry 603 (also referred to as a processor, e.g., corresponding to processing circuitry 1102 of FIG. 11, and control system 1412 of FIG. 14) coupled to the transceiver circuitry, and memory circuitry 605 (also referred to as memory, e.g., corresponding to memory 1110 of FIG. 10) coupled to the processing circuitry 603. The memory circuitry 605 may include computer readable program code that when executed by the processing circuitry 603 causes the processing circuitry 603 to perform operations according to embodiments disclosed herein. According to other embodiments, processing circuitry 603 may be defined to include memory so that separate memory circuitry is not required. Communication device 600 may also include an interface (such as a user interface) coupled with processing circuitry 603, and/or communication device 600 may be incorporated in (or may include) an internet-of-things (“IoT”) device, a vehicle, an autonomous vehicle, a road side unit (“RDU”), or an unmanned aerial vehicle (“UAV”). In some examples, a RSU is part of a road infrastructure and provides road related information to passing cars using a NR sidelink.

As discussed herein, operations of communication device 600 may be performed by processing circuitry 603 and/or transceiver circuitry 601. For example, processing circuitry 603 may control transceiver circuitry 601 to transmit communications through transceiver circuitry 601 over a radio interface to a radio access network node (also referred to as a base station) and/or to receive communications through transceiver circuitry 601 from a RAN node over a radio interface. Moreover, modules may be stored in memory circuitry 605, and these modules may provide instructions so that when instructions of a module are executed by processing circuitry 603, processing circuitry 603 performs respective operations (e.g., operations discussed below with respect to Example Embodiments relating to wireless communication devices). According to some embodiments, a communication device 600 and/or an element(s)/function(s) thereof may be embodied as a virtual node/nodes and/or a virtual machine/machines.

FIG. 7 is a block diagram illustrating elements of a radio access network (“RAN”) node 700 (also referred to as a network node, base station, E-UTRAN NodeB (eNodeB/eNB), gNodeB/gNB, etc.) of a RAN configured to provide cellular communication according to embodiments of inventive concepts. (RAN node 700 may be provided, for example, as discussed below with respect to network node 1010A, 1010B of FIG. 10, network node 1200 of FIG. 12, hardware 1404 or virtual machine 1408A, 1408B of FIG. 14, and/or base station 1504 of FIG. 15, all of which should be considered interchangeable in the examples and embodiments described herein and be within the intended scope of this disclosure, unless otherwise noted.) As shown, the RAN node 700 may include transceiver circuitry 701 (also referred to as a transceiver, e.g., corresponding to portions of RF transceiver circuitry 1212 and radio front end circuitry 1218 of FIG. 12) including a transmitter and a receiver configured to provide uplink and downlink radio communications with mobile terminals. The RAN node 700 may include network interface circuitry 707 (also referred to as a network interface, e.g., corresponding to portions of communication interface 1206 of FIG. 12) configured to provide communications with other nodes (e.g., with other base stations) of the RAN and/or core network (“CN”). The network node 700 may also include processing circuitry 703 (also referred to as a processor, e.g., corresponding to processing circuitry 1202 of FIG. 12) coupled to the transceiver circuitry 701, and memory circuitry 705 (also referred to as memory, e.g., corresponding to memory 1204 of FIG. 12) coupled to the processing circuitry. The memory circuitry 705 may include computer readable program code that when executed by the processing circuitry 703 causes the processing circuitry 703 to perform operations according to embodiments disclosed herein. According to other embodiments, processing circuitry 703 may be defined to include memory so that a separate memory circuitry 705 is not required.

As discussed herein, operations of the RAN node 700 may be performed by processing circuitry 703, network interface 707, and/or transceiver 701. For example, processing circuitry 703 may control transceiver 701 to transmit downlink communications through transceiver 701 over a radio interface to one or more mobile terminals UEs and/or to receive uplink communications through transceiver 701 from one or more mobile terminals UEs over a radio interface. Similarly, processing circuitry 703 may control network interface 707 to transmit communications through network interface 707 to one or more other network nodes and/or to receive communications through network interface from one or more other network nodes. Moreover, modules may be stored in memory 705, and these modules may provide instructions so that when instructions of a module are executed by processing circuitry 703, processing circuitry 703 performs respective operations (e.g., operations discussed below with respect to Example Embodiments relating to RAN nodes). According to some embodiments, RAN node 700 and/or an element(s)/function(s) thereof may be embodied as a virtual node/nodes and/or a virtual machine/machines.

According to some other embodiments, a network node may be implemented as a core network (“CN”) node without a transceiver. In such embodiments, transmission to a wireless communication device UE may be initiated by the CN node so that transmission to the wireless communication device UE is provided through a network node including a transceiver (e.g., through a base station or RAN node). According to embodiments where the network node is a RAN node including a transceiver, initiating transmission may include transmitting through the transceiver.

FIG. 8 is a block diagram illustrating elements of a CN node (e.g., an SMF (session management function) node, an AMF (access and mobility management function) node, etc.) of a communication network configured to provide cellular communication according to embodiments of inventive concepts. (CN node 800 may be provided, for example, as discussed below with respect to core network node 1008 of FIG. 10, hardware 1404 or virtual machine 1408A, 1408B of FIG. 14, all of which should be considered interchangeable in the examples and embodiments described herein and be within the intended scope of this disclosure, unless otherwise noted) As shown, the CN node 800 may include network interface circuitry 807 configured to provide communications with other nodes of the core network and/or the radio access network RAN. The CN node 800 may also include a processing circuitry 803 (also referred to as a processor,) coupled to the network interface circuitry, and memory circuitry 805 (also referred to as memory) coupled to the processing circuitry. The memory circuitry 805 may include computer readable program code that when executed by the processing circuitry 803 causes the processing circuitry 803 to perform operations according to embodiments disclosed herein. According to other embodiments, processing circuitry 803 may be defined to include memory so that a separate memory circuitry is not required.

As discussed herein, operations of the CN node 800 may be performed by processing circuitry 803 and/or network interface circuitry 807. For example, processing circuitry 803 may control network interface circuitry 807 to transmit communications through network interface circuitry 807 to one or more other network nodes and/or to receive communications through network interface circuitry from one or more other network nodes. Moreover, modules may be stored in memory 805, and these modules may provide instructions so that when instructions of a module are executed by processing circuitry 803, processing circuitry 803 performs respective operations (e.g., operations discussed below with respect to Example Embodiments relating to core network nodes). According to some embodiments, CN node 800 and/or an element(s)/function(s) thereof may be embodied as a virtual node/nodes and/or a virtual machine/machines.

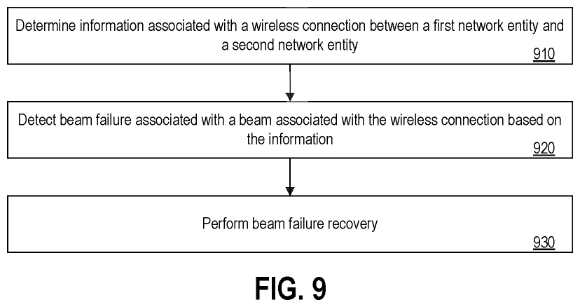

In the description that follows, while the first network entity may be any of the communication device 600, UE 1012A-D, 1100, 1506, RAN node 700, network node 1010A, 1010B, 1200, 1504, hardware 1404, or virtual machine 1408A, 1408B, the communication device 700 shall be used to describe the functionality of the operations of the first network entity. Operations of the communication device 600 (implemented using the structure of FIG. 6) will now be discussed with reference to the flow chart of FIG. 9 according to some embodiments of inventive concepts. For example, modules may be stored in memory 605 of FIG. 6, and these modules may provide instructions so that when the instructions of a module are executed by respective communication device processing circuitry 603, processing circuitry 603 performs respective operations of the flow chart.

FIG. 9 illustrates an example of operations performed by a first network entity operating in a communication network. In some embodiments, the first network entity includes at least one of: an IoT device; a vehicle; an autonomous vehicle; a RSU; and a UAV

At block 910, processing circuitry 603 determines information associated with a wireless connection between the first network entity and a second network entity of the communications network.

In some embodiments, the first network entity is a communication device and the second network entity is a network node. The wireless connection can include at least one of RRC signaling, a MAC CE, control PDU of a protocol layer, and layer 1 signaling on a physical channel.

In additional or alternative embodiments, the first network entity is a first communication device and the second network entity is a second communication device. The wireless connection can include at least one of: radio resource control signaling, sidelink signaling, discovery signaling, media access control control element, control protocol data unit of a protocol layer; and layer 1 signaling on a physical channel. In additional or alternative embodiments, the communication devices are sidelink communication devices configured to communicate with each other via a sidelink frequency.

In additional or alternative embodiments, determining the information includes determining at least one of: a reference signal received power, RSRP; reference signal received quality, RSRQ; signal-to-interference noise ratio, SINR; and received signal strength indicator, RSSI.

In additional or alternative embodiments, determining the information includes determining a distance between the first network entity and the second network entity.

In additional or alternative embodiments, determining the information includes determining a mobility of at least one of the first network entity and the second network entity.

In additional or alternative embodiments, determining the information includes receiving an indication from the second network entity regarding the channel quality.

In additional or alternative embodiments, determining the information includes determining a traffic inactivity associated with the beam.

At block 920, processing circuitry 603 detects beam failure associated with a beam associated with the wireless connection based on the information. In some embodiments, detecting the beam failure includes determining that the information exceeds a threshold value. In additional or alternative embodiments, detecting the beam failure includes predicting the beam failure based on inputting the information to a machine learning model.

At block 930, processing circuitry 603 performs beam failure recovery.

In some embodiments, performing the beam failure recovering includes transmitting a discovery message over a non-failed beam to the second network entity and, responsive to receiving a reply to the discovery message, selecting the non-failed beam as serving beam.

In additional or alternative embodiments, performing beam failure recovery includes transmitting a recovery message over a non-failed beam to the second network entity. The recovery message can indicate configuration information for restoring the beam using a different configuration.

In additional or alternative embodiments, performing beam failure recovery includes transmitting an indication of the beam failure to a network node.

In additional or alternative embodiments, performing beam failure recovery includes releasing the sidelink connection with the second network entity.

In additional or alternative embodiments, performing beam failure recovery includes triggering sidelink discovery of a new sidelink communication device.

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2^{nd} Generation (2G), 3^{rd} Generation (3G), 4^{th} Generation (4G), 5G standards, or any applicable future generation standard (e.g., 6^{th} Generation (6G)); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub-that is, a hub whose primary function is to route communications to/from the UEs from/to the network node 1010b. In other embodiments, the hub 1014 may be a non-dedicated hub-that is, a device which is capable of operating to route communications between the UEs and network node 1010b, but which is additionally capable of operating as a communication start and/or end point for certain data channels.

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a Universal Subscriber Identity Module (USIM) and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay (RL). A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

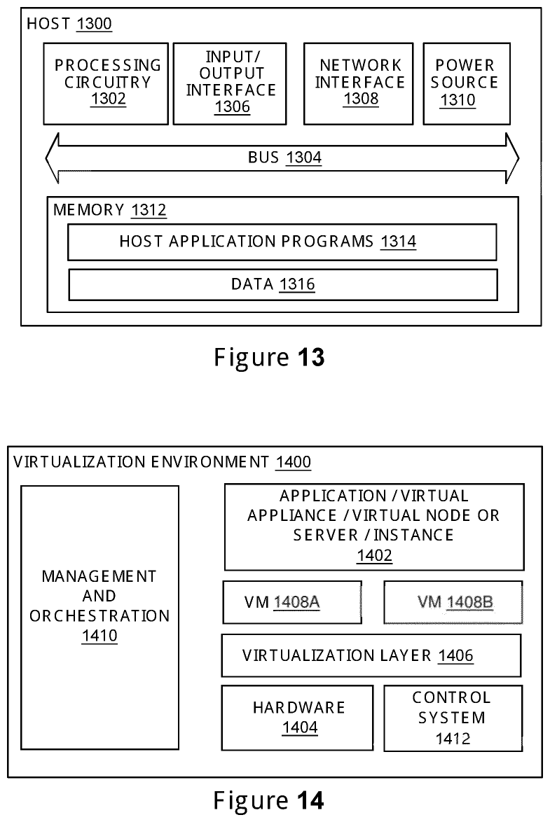

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may allow a multi-node cloud-based system (e.g., a FaaS system) to schedule functions based on requirements of the function and a status of the cloud-based system, and thereby ensure E2E RT runtimes for RT functions.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

1. A method of operating a first network entity of a communications network, the first network entity configured to support multi-beam operations, the method comprising:
determining (910) information associated with a wireless connection between the first network entity and a second network entity of the communications network;
detecting (920) beam failure associated with a beam associated with the wireless connection based on the information; and
performing (930) beam failure recovery.

2. The method of Embodiment 1, wherein the first network entity is a communication device,
wherein the second network entity is a network node, and
wherein the wireless connection comprises at least one of: radio resource control signaling, medium access control, MAC, control element, control protocol data unit of a protocol layer; and layer 1 signaling on a physical channel.

3. The method of Embodiment 1, wherein the first network entity is a first communication device,
wherein the second network entity is a second communication device, and
wherein the wireless connection comprises at least one of: radio resource control signaling, sidelink signaling, discovery signaling, medium access control, MAC, control element, control protocol data unit of a protocol layer; and layer 1 signaling on a physical channel.

4. The method of Embodiment 3, wherein the communications network comprises a sidelink network,
wherein the first network entity is a first sidelink communication device,
wherein the second network entity is a second sidelink communication device, and
wherein the first sidelink communication device is configured to communicate with the second sidelink communication device via a sidelink frequency.

5. The method of Embodiment 4, wherein performing beam failure recovery comprises triggering sidelink discovery of a new sidelink communication device.

6. The method of any of Embodiments 1-5, wherein determining the information comprises determining at least one of: a reference signal received power, RSRP; reference signal received quality, RSRQ; signal-to-interference noise ratio, SINR; and received signal strength indicator, RSSI.

7. The method of any of Embodiments 1-6, wherein determining the information comprises determining a distance between the first network entity and the second network entity.

8. The method of any of Embodiments 1-7, wherein determining the information comprises determining a mobility of at least one of the first network entity and the second network entity.

9. The method of any of Embodiments 1-8, wherein determining the information comprises receiving an indication from the second network entity regarding the channel quality.

10. The method of any of Embodiments 1-9, wherein determining the information comprises determining a traffic inactivity associated with the beam.

11. The method of any of Embodiments 1-10, wherein detecting the beam failure comprises determining that the information exceeds a threshold value.

12. The method of any of Embodiments 1-10, wherein detecting the beam failure comprises predicting the beam failure based on inputting the information to a machine learning model.

13. The method of any of Embodiments 1-12, wherein performing beam failure recovery comprises:
transmitting a discovery message over a non-failed beam to the second network entity; and
responsive to receiving a reply to the discovery message, selecting the non-failed beam as serving beam.

14. The method of any of Embodiments 1-13, wherein performing beam failure recovery comprises:
transmitting a recovery message over a non-failed beam to the second network entity, the recovery message indicating configuration information for restoring the beam using a different configuration.

15. The method of any of Embodiments 1-14, wherein performing beam failure recovery comprises:
transmitting an indication of the beam failure to a network node.

16. The method of any of Embodiments 1-15, wherein performing beam failure recovery comprises:
releasing the sidelink connection with the second network entity.

17. The method of any of Embodiments 1-16, wherein the first network entity comprises at least one of: an internet-of-things, IoT, device; a vehicle; an autonomous vehicle; a road side unit, RSU; and an unmanned aerial vehicle, UAV.

### Group C Embodiments

18. A first network entity (600, 700) operating in a communications network, the first network entity comprising:
processing circuitry (603, 703); and
memory (605, 705) coupled to the processing circuitry and having instructions stored therein that are executable by the processing circuitry to cause the first network entity to perform operations comprising any of the operations of Embodiments 1-17.

19. A computer program comprising program code to be executed by processing circuitry (603, 703) of a first network entity (600, 700) operating in a communications network, whereby execution of the program code causes the first network entity to perform operations comprising any operations of Embodiments 1-17.

20. A computer program product comprising a non-transitory storage medium (605, 705) including program code to be executed by processing circuitry (603, 703) of a first network entity (600, 700) operating in a communications network, whereby execution of the program code causes the first network entity to perform operations comprising any operations of Embodiments 1-17.

21. A non-transitory computer-readable medium having instructions stored therein that are executable by processing circuitry (603, 703) of a first network entity (600, 700) operating in a communications network to cause the first network entity to perform operations comprising any of the operations of Embodiments 1-17.

1-46. (canceled)

47. A method of operating a first sidelink communication device of a communications network, the first sidelink communication device configured to support multi-beam operations, the method comprising:
determining information associated with a wireless connection between the first sidelink communication device and a second sidelink communication device of the communications network, wherein the wireless connection comprises multiple beams;
detecting beam failure associated with a beam associated with the wireless connection based on the information; and
performing beam failure recovery by (i) transmitting a discovery message over a remaining non-failed beam to the second sidelink communication device in order to select the non-failed beam as serving beam responsive to receiving a reply to the discovery message, or (ii) transmitting a recovery message over a remaining non-failed beam to the second sidelink communication device in order to restore the failed beam using a different configuration.

48. The method of claim 47, wherein the wireless connection comprises at least one of: radio resource control signaling, sidelink signaling, discovery signaling, medium access control, MAC, control element, control protocol data unit of a protocol layer; and layer 1 signaling on a physical channel.

49. The method of claim 47, wherein the communications network comprises a sidelink network, and
wherein the first sidelink communication device is configured to communicate with the second sidelink communication device via a sidelink frequency.

50. The method of claim 47, wherein determining the information comprises determining at least one of: a reference signal received power, RSRP; reference signal received quality, RSRQ; signal-to-interference noise ratio, SINR; and received signal strength indicator, RSSI.

51. The method of claim 47, wherein determining the information comprises determining a distance between the first sidelink communication device and the second sidelink communication device.

52. The method of claim 47, wherein determining the information comprises determining a mobility of at least one of the first sidelink communication device and the second sidelink communication device.

53. The method of claim 47, wherein determining the information comprises receiving an indication from the second sidelink communication device regarding the channel quality.

54. The method of claim 47, wherein determining the information comprises determining a traffic inactivity associated with the beam.

55. The method of claim 47, wherein detecting the beam failure comprises determining that the information exceeds a threshold value.

56. The method of claim 47, wherein detecting the beam failure comprises predicting the beam failure based on inputting the information to a machine learning model.

57. The method of claim 47, wherein the recovery message indicates configuration information for restoring the beam using the different configuration.

58. The method of claim 47, wherein performing beam failure recovery further comprises:
transmitting an indication of the beam failure to a network node.

59. The method of claim 47, wherein the first sidelink communication device comprises at least one of: an internet-of-things, IoT, device; a vehicle; an autonomous vehicle; a road side unit, RSU; and an unmanned aerial vehicle, UAV.

60. A first sidelink communication device configured to operate in a communications network, the first sidelink communication device configured to support multi-beam operations, and to:
determine information associated with a wireless connection between the first sidelink communication device and a second sidelink communication device of the communications network, wherein the wireless connection comprises multiple beams;
detect beam failure associated with a beam associated with the wireless connection based on the information; and
perform beam failure recovery by (i) transmitting a discovery message over a remaining non-failed beam to the second sidelink communication device in order to select the non-failed beam as serving beam responsive to receiving a reply to the discovery message, or (ii) transmitting a recovery message over a remaining non-failed beam to the second sidelink communication device in order to restore the failed beam using a different configuration.

61. The first sidelink communication device of claim 60, wherein the wireless connection comprises at least one of: radio resource control signaling, sidelink signaling, discovery signaling, medium access control, MAC, control element, control protocol data unit of a protocol layer; and layer 1 signaling on a physical channel.

62. The first sidelink communication device of claim 60, wherein the communications network comprises a sidelink network, and
wherein the first sidelink communication device is configured to communicate with the second sidelink communication device via a sidelink frequency.

63. The first sidelink communication device of claim 60, wherein the first sidelink communication device is configured to determine the information by determining at least one of: a reference signal received power, RSRP; reference signal received quality, RSRQ; signal-to-interference noise ratio, SINR; and received signal strength indicator, RSSI.

64. The first sidelink communication device of claim 60, wherein the first sidelink communication device is configured to determine the information by determining a distance between the first sidelink communication device and the second sidelink communication device.

65. The first sidelink communication device of claim 60, wherein the first sidelink communication device is configured to determine the information by determining a mobility of at least one of the first sidelink communication device and the second sidelink communication device.

66. The first sidelink communication device of claim 60, wherein the first sidelink communication device is configured to determine the information by receiving an indication from the second sidelink communication device regarding the channel quality.

67. The first sidelink communication device of claim 60, wherein the first sidelink communication device is configured to determine the information by determining a traffic inactivity associated with the beam.

68. The first sidelink communication device of claim 60, wherein the first sidelink communication device is configured to detect the beam failure by determining that the information exceeds a threshold value.

69. The first sidelink communication device of claim 60, wherein the first sidelink communication device is configured to detect the beam failure by predicting the beam failure based on inputting the information to a machine learning model.

70. The first sidelink communication device of claim 60, wherein the recovery message indicates configuration information for restoring the beam using the different configuration.

71. The first sidelink communication device of claim 60, wherein the first sidelink communication device is further configured to perform beam failure recovery by:
transmitting an indication of the beam failure to a network node.

72. The first sidelink communication device of claim 60, wherein the first sidelink communication device comprises at least one of: an internet-of-things, IoT, device; a vehicle; an autonomous vehicle; a road side unit, RSU; and an unmanned aerial vehicle, UAV.
